(19) United States
(12) Patent Application Publication
(10) Pub. No.: US 2013/0097078 A1
(43) Pub. Date: Apr. 18, 2013

(54) MOBILE REMOTE PAYMENT SYSTEM

(71) Applicants: Shoon Ping Wong, Stamford, CT (US); James J. Anderson, Mount Vernon, NY (US); Jonathan Main, Hampshire (GB)

(72) Inventors: Shoon Ping Wong, Stamford, CT (US); James J. Anderson, Mount Vernon, NY (US); Jonathan Main, Hampshire (GB)

(21) Appl. No.: 13/274,775

(22) Filed: Oct. 17, 2011

(51) Int. Cl. G06Q 20/22

(52) U.S. Cl. 705/44

(57) ABSTRACT

Methods, systems, apparatus and computer program products for implementing a mobile remote payment system that allows consumers and merchants to engage in mobile remote payment transactions regardless of their registration point are described. In an embodiment, a mobile remote payment (MRP) switch computer receives from an originating service manager computer, a payment authorization request that comprises payment data, an originating service manager identifier, and a merchant identifier of a merchant. The MRP switch computer verifies the originating service manager identifier, determines that the merchant is affiliated with the receiving service manager, generates enriched payment instructions that include a switching identifier, transmits the enriched payment instructions to a receiving service manager computer, receives a payment authorization response from the receiving service manager computer that includes an electronic receipt, and transmits the payment authorization response and the electronic receipt to the originating service manager computer.

### BACKGROUND

Embodiments disclosed herein relate to mobile remote payment systems and methods. In particular, embodiments relate to methods, apparatus, systems, means and computer program products for implementing a mobile remote payment system that allows consumers and merchants to engage in mobile remote payment transactions regardless of their registration point.

Payment card systems are in widespread use. A prominent payment card system is operated by the assignee hereof, MasterCard International Incorporated, and by its member financial institutions. Such payment card systems have been adapted to process transactions initiated from a consumer's mobile device (such as a mobile telephone) by associating an identifier stored in the mobile device with one or more financial accounts of the consumer (such as a credit card account). A consumer can therefore purchase goods or services from merchants with his or her mobile device without presenting a credit or debit card. An example of the operation of a mobile telephone to initiate funds transfers via a payment card system is described in commonly assigned U.S. published Patent Application 2008/0249928 A1, filed Aug. 10, 2007, entitled “Payment Card Based Remittance System with Designation of Recipient By Mobile Telephone Number”, which is incorporated herein by reference. A mobile remote payments (MRP) system that can handle such mobile device payment transactions includes, for example, an issuer financial institution (Issuer FI) that partners with a mobile network operator (MNO) and a Service Manager. The MNO may act as a program sponsor, and the Issuer FI is the entity that issues payment card accounts to consumers (cardholders). The Service Manager registers cardholders and merchants wishing to participate in the MRP system, and the Issuer FI can be affiliated with the Service Manager. In such systems, each merchant typically has a merchant account (which may be a financial payment card account) with an acquirer financial institution (Acquirer FI).

FIG. 1 is a block diagram of an example embodiment of a MRP system 100, which may be part of a larger system, to illustrate a mobile remote payment transaction between a consumer (not shown) having a mobile device 104 and a merchant (not shown) having a merchant device 102. The merchant device 102 may be, for example, a point-of-sale (POS) terminal, a suitably programmed mobile telephone, or a PDA (personal digital assistant) with communication capabilities. (The latter two possible embodiments of the merchant device may, for example, be particularly appropriate for merchants who operate without a fixed place of business. Examples of such merchants may be flea market sellers, artisans and crafters who sell their handiwork at craft fairs, itinerant merchants or merchants in third world marketplaces.) If the merchant device is a POS terminal, it may operate in a conventional manner and/or may have functionality that actively contributes to the transaction flow. The merchant device 102 may be configured to display transaction information to be read by the consumer. For example, the merchant device may display a total amount due for a transaction along with a merchant identification number (or the merchant ID could be permanently displayed by a sticker affixed to a portion of the merchant device 102). (In some embodiments, the merchant identification number may be the account number that identifies the merchant's payment card account to which payment transactions are to be routed, or it may be the mobile telephone number or another mobile identifier, would be particularly convenient where the merchant device 102 is a mobile telephone.) The merchant device 102 may be capable of wirelessly transmitting the transaction information to the customer device 104. For example, transfer of the transaction information may be via wireless communication from the merchant device 102 to the customer device 104 using near field communication (NFC) technology, or via a mobile telephone network using text messaging or the like. In some embodiments, the consumer may be required to manually input the transaction information into the consumer mobile device 104.

In this example, the consumer mobile device 104 is configured for making payments and is registered with Service Manager A computer 110, and the merchant device 102 is also registered with Service Manager A. In addition, the consumer's mobile device 104 is associated with a cardholder account 106 (for example, a credit card account, debit card account or other financial account) of an Issuer FI 108. The Service Manager A launched the MRP system 100 in an issuer domain, for example a geographical region that includes a portion of the Midwest United States in which the Issuer FI 108 is located. The Issuer FI 108 partnered with a Mobile Network Operator (not shown) that acts as the program sponsor. The Service Manager 110 also registered an Acquirer FI 112, which holds the merchant account 114 of the merchant 102, to participate in the MRP system 100. The Acquirer FI 112 may include a group of merchants (a “Merchant Group”) that includes the owner of the merchant device 102. All Merchant Group members may accept and display a “Mobile Remote Payment” brand logo sign as a prominent mobile payment acceptance mark, which sign lets consumers know that the merchant is part of the MRP system 100.

The Service Manager 110, Acquirer FI 112, payment system or network 116, and the Issuer FI 108 blocks shown in FIG. 1 may each represent one or more computers or servers or network computer systems for receiving, transmitting and processing data. For example, the payment system 116 (which may be the well-known Banknet™ system operated by the assignee hereof) routes transaction data between the Acquirer FI 112 and the Issuer FI 108, and may include several computers and/or computer servers for processing and routing the data.

The Service Manager computer 110 is configured for communicating (by wireless communications and/or landline communications) with each of the merchant device 102, the customer's mobile device 104 and the Acquirer FI 112. In some implementations, the Service Manager computer 110 provides front end processing, which may include “on behalf” and/or value added services, for the Issuer FI 108 and/or, in some cases, for the Acquirer FI 112. The Service Manager computer 110 also can operate to relay communications between the merchant device 102 and the consumer's mobile device 104, and between the consumer's mobile device 104 and the customer Issuer FI 108.

Arrows 120 to 136 trace the path of a mobile remote payment transaction, which begins with the customer's mobile device 104 transmitting 120 a payment request to the Service Manager A computer 110. The consumer device 104 is first authenticated and/or validated by the Service Manager A computer 110, which then constructs a payment authorization request and routes 122 it to the participating Acquirer FI 112. The Acquirer FI routes 124 the payment authorization request to the payment system 116 which forwards 126 it to the Issuer FI 108 that has the cardholder account 106 of the consumer. If all is in order (i.e., the cardholder account has sufficient funds to cover payment), then an authorization response is transmitted 128 to the payment system 116 which routes 130 it to the Acquirer FI 112 for crediting the merchant account 114. The Acquirer FI then transmits 132 a successful payment message to the Service Manager computer 110, which notifies 134 the merchant device 102 that payment has been received (or will be credited to the merchant account 114) for the goods and/or services. In addition, the Service Manager 110 transmits 136 a digital receipt to the consumer device 104 confirming that payment was made. Upon completion of the payment transaction, for example, the consumer can leave the merchant's store with the goods. In some cases, a subsequent clearing transaction that may be initiated by the merchant results in a transfer of the payment amount from the consumer's payment card account 106 to the merchant's account 114.

Thus, the Service Manager registers cardholders, merchants and financial institutions, may hold cardholder account details, authenticates cardholders, submits transactions to the Acquirer FI for processing, and interacts with the cardholders and merchants during mobile remote payment transactions. However, a problem arises when a consumer who is registered with Service Manager A wishes to engage in a mobile remote payment transaction with a second merchant who is registered with, for example, a Service Manager B (not shown in FIG. 1) because Service Manager A and Service Manager B typically do not have the same consumers and/or merchants (or Merchant Groups) registered or in common. Thus, Service Manager A presides over a first closed-loop MRP system and Service Manager B presides over a second, different closed-loop MRP system that typically are not compatible. Of course, consumers having consumer devices registered with Service Manager A do not wish to be limited to making mobile remote payments only with merchants registered with Service Manager A (and thus who are part of the first closed-loop MRP system), and merchants having merchant devices registered with Service Manager B also want to be able to transact with all consumers, not just those registered with their Service Manager.

The present inventors recognized that a need exists for mobile remote payment system interoperability so that all consumers with mobile devices capable of making payment transactions can transact with all merchants who accept MRP transactions, regardless of their registration point. The present inventors also recognized that the novel MRP transaction systems and techniques described herein not only provide interoperability, but also provide the opportunity to supply value-added services to customers, merchants and/or financial institutions.

### BRIEF DESCRIPTION OF THE DRAWINGS

Features and advantages of some embodiments, and the manner in which the same are accomplished, will become more readily apparent with reference to the following detailed description taken in conjunction with the accompanying drawings, which illustrate exemplary embodiments (not necessarily drawn to scale), wherein:

FIG. 1 is a block diagram that illustrates a conventional mobile remote payment system.

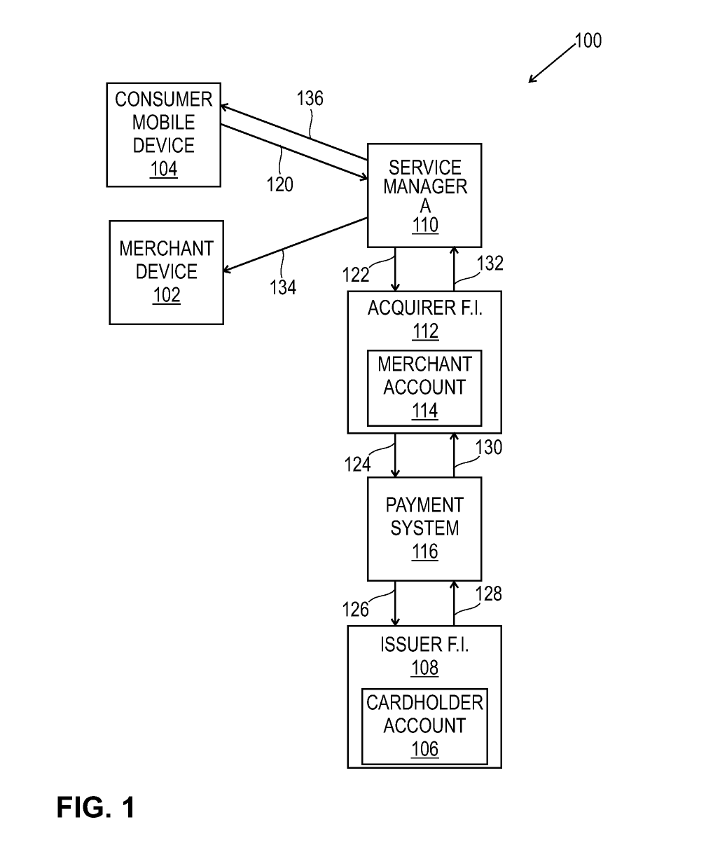

FIG. 2 is a block diagram that illustrates a mobile remote payment transaction system in accordance with aspects of the present invention.

FIG. 3 is a block diagram illustrating an example of the components of a merchant device shown in FIG. 2.

FIG. 4 is a block diagram illustrating an example of the components of the consumer mobile telephone of FIG. 2.

FIG. 5 is a block diagram illustrating an example of the components of a Service Manager Computer of FIG. 2.

FIG. 6 is a block diagram illustrating an example of the components of a mobile remote payments switching computer shown in FIG. 2.

FIG. 7 is a flowchart illustrating a process according to the invention that may be performed by a mobile remote payments switching computer in connection with a payment transaction handled by the system of FIG. 2.

FIG. 8 is a block diagram that illustrates another embodiment of a mobile remote payment transaction system in accordance with aspects of the present invention.

FIG. 9 is a flowchart illustrating a process according to the invention that may be performed by a mobile remote payments switching computer in connection with a mobile remote payment transaction handled by the system of FIG. 8.

### DETAILED DESCRIPTION

In general, and for the purpose of introducing concepts of embodiments of the present invention, mobile remote payment (MRP) systems and methods are disclosed for handling payment transactions between a customer or consumer having a mobile device (such as a mobile telephone) and a merchant having a merchant device (such as a point-of-sale (POS) terminal, or an appropriately configured mobile telephone). It should be understood that the terms “consumer” and “customer” are used interchangeably herein to designate a purchaser of goods or services.

The disclosed MRP systems can handle mobile remote payment transactions between customers registered with an originating Service Manager and merchants who are not registered with the originating Service Manager. In some embodiments, a portion of the transaction information, such as an amount due for the purchase and a code that identifies the merchant, may be entered by the consumer into her mobile device, or may be transmitted to the consumer's device by a merchant device. In the former case, transaction information may be displayed by a merchant's device (such as on a display screen of a POS terminal) to be read by the customer and manually entered by the customer into the consumer's device (such as a mobile telephone). In some embodiments, the customer operates his or her mobile telephone to initiate a request for a payment transaction via the Issuer financial institution (Issuer FI) of the customer's payment card account. The MRP system processes the payment authorization request to include instructions directing the customer's Issuer FI to implement a transfer of funds from the customer's payment card account to the merchant's payment card account, which is held at an Acquirer financial institution (Acquirer FI) of the merchant. The vehicle for the mobile remote payment transaction is the MRP system, which may be supported by at least one payment card system. In some embodiments, an originating Service Manager computer routes a registered consumer's payment request to a MRP switch computer if the merchant is not registered with the originating Service Manager. In some embodiments, the MRP switch computer facilitates the payment transaction by identifying a second Service Manager affiliated with the merchant, and provides an enriched payment request to the second Service Manager. The second Service Manager then transmits a payment authorization request to a payment network, which routes it to the Issuer FI that holds the consumer's cardholder account.

The Issuer FI transmits a payment authorization response if all is in order with the cardholder's account, and causes payment to be routed via the payment network to the Acquirer FI for crediting to the merchant's payment card account. In some embodiments, the Acquirer FI notifies the second Service Manager of the authorized payment response. Upon authorization and/or the completion of the payment transaction, the second Service Manager (associated with the merchant) confirms to the merchant that the funds transfer has occurred (or will occur subsequently during conventional clearing operations). In response to receiving the confirmation of payment, the merchant transfers ownership of the goods to the customer, or accepts the confirmation as payment for services rendered or to be rendered to the consumer.

In some described systems, the mobile remote payment transaction enters the MRP system via a consumer mobile device to an originating Service Manager and next through an MRP switch computer, rather than originating from the merchant's POS terminal and the Acquiring FI. Certain advantages of the novel MRP systems and transaction processes described herein have been alluded to above and will be discussed in more detail below, along with other advantages and advantageous features.

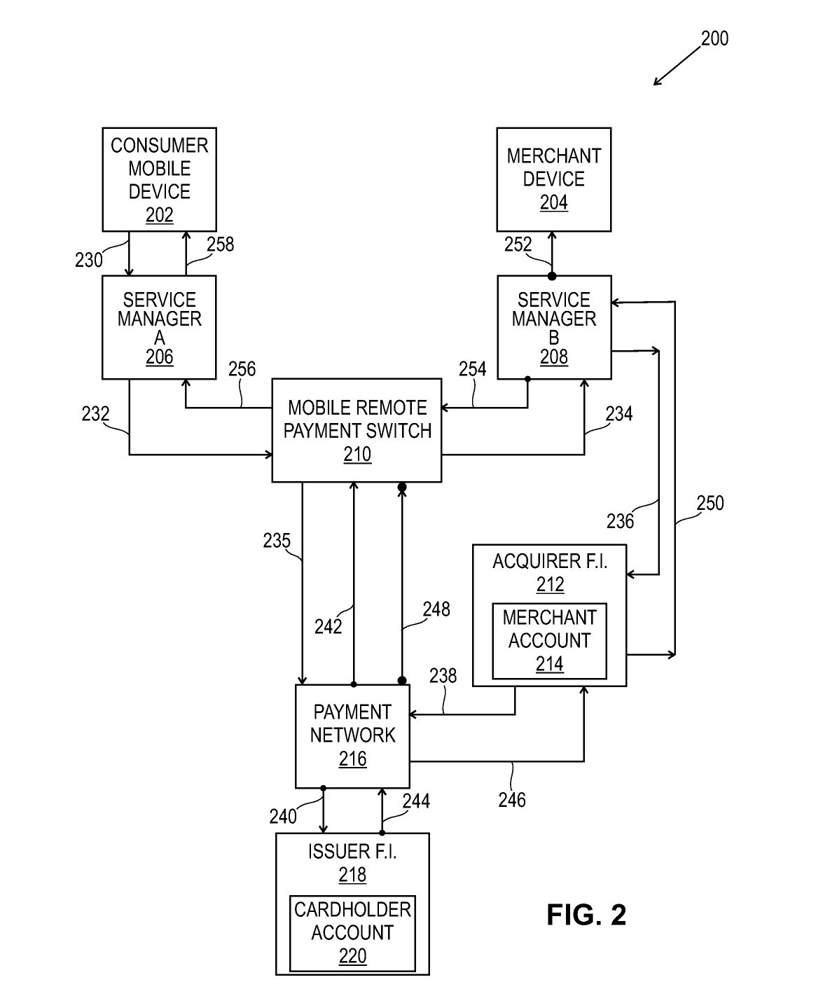

FIG. 2 is a block diagram that illustrates an embodiment of a MRP transaction-handling system 200. A consumer having a consumer mobile device 202 wishes to purchase an item from a merchant having a merchant device 204. The merchant device 204 may be, for example, a POS terminal or a suitably programmed mobile telephone or PDA (personal digital assistant) with communication capabilities. (The latter two possible embodiments of the merchant device may, for example, be particularly appropriate for merchants who operate without a fixed place of business. Examples of such merchants may be flea market sellers, artisans and crafters who sell their handiwork at craft fairs, itinerant merchants or merchants in third world marketplaces.) If the merchant device is a POS terminal, it may operate in a conventional manner and/or may have functionality that actively contributes to the transaction flow. The consumer uses her mobile device 202 to transmit transaction information, which includes, in some embodiments, a customer identifier, a payment amount and a merchant identifier, to a Service Manager A computer 206.

It should be noted that, in this example the consumer registered her consumer mobile device for making mobile remote payments with the Service Manager A. In addition, Service Manager A is affiliated with a first mobile network operator (MNO), and the merchant has a merchant device that is registered with a Service Manager B that is affiliated with a second MNO (the first MNO communications system may be incompatible with the second MNO communications system). Thus, when communications are initiated by consumer mobile device 202, the Service Manager A computer 206 recognizes that consumer mobile device, but does not recognize the merchant information. This is because Service Manager A and Service Manager B may have registered consumers and registered merchants that are mutually exclusive of each other. Therefore, in some embodiments, the Service Manager B computer 208 cannot recognize the information regarding the consumer mobile device 202. Thus, a Mobile Remote Payment (MRP) switch computer 210 is provided to bridge the consumers and merchants who belong to the separate mobile remote payment organizations (of Service Manager A and Service Manager B). Such operation enables consumers to utilize their mobile devices to make mobile remote payments regardless of which Service Manager he or she is registered and/or affiliated with, and likewise permits merchants to accept payments from consumers who are not registered with their Service Manager. In some embodiments, the MRP switch computer 210 may be owned and/or operated by a payment card organization (e.g., the assignee hereof) that operates and maintains a payment network for routing payment transactions between customer Issuer FIs and merchant Acquirer FIs.

For example, a mobile remote payments system that includes Service Manager A and MNO A may have been launched in an issuer domain, for example a geographical region that includes a large portion of the Midwestern United States in which the Issuer FI is located and/or is operating. Service Manager A thus registers consumers who reside in that region (and merchants having places of business in that region) for the mobile remote payment service. Similarly, Service Manager B and MNO B may have been launched in an acquirer domain, for example a geographical region that includes the Pacific Northwest of the United States in which the Acquirer FI of the group of merchants is located and/or is operating. In another example, Store X may register a first group of consumers for Store X cards with Service Manager A that can be used where they are accepted in a first closed system, and Store Y may register a second group of consumer for Store Y cards with Service Manager B that can be used in their stores in a second closed system. Consumers in the first group with Store X cards may wish to utilize them to purchase goods from Store Y and vice-versa, which is made possible by the MRP system 200. In particular, even though there may be little or no overlap regarding the consumers and merchants registered with Service Manager A and those registered with Service Manager B, the MRP system 200 is configured to bridge the gap between registered users of the different Service Managers.

Referring again to FIG. 2, the MRP switch computer 210 is operable to communicate with both the Service Manager A computer 206 and the Service Manager B computer 208. In some embodiments, the MRP switch computer 210 can also communicate with a payment network 216. In the illustrated embodiment, during a mobile remote payment transaction Service Manager B computer 208 is configured to communicate with the MRP switch computer 210, the merchant device 204 and an Acquirer FI 212 that holds a merchant account 214 associated with the merchant. The Acquirer FI 212 is configured to communicate with a payment network 216, which may be the Banknet™ system mentioned above that is operated by the assignee hereof. The payment network 216 is operable to communicate with the Acquirer FI 212, with the Issuer FI 218 (that issued the cardholder account 218 associated with the consumer device 202 of the consumer), and in some embodiments with the MRP switch computer 210.

In FIG. 2, arrows 230 to 258 trace the path of a mobile remote payment transaction that starts from the customer's mobile device 202. In particular, in some embodiments the consumer (who is the cardholder or the financial account holder) initiates a payment authorization request by entering a consumer identifier into her mobile phone 202 (or by selecting a mobile wallet account that may be pre-set in her mobile device). The consumer identifier can be a credit card number, debit card number or some other financial account number. The consumer then enters a payment amount for an item or service and a merchant identifier. In some embodiments, a mobile telephone number associated with the consumer's mobile device 202 may be accepted as the consumer identifier. Regarding the merchant identifier, a display screen of the merchant device 204 may display a merchant identification number with a total amount due for a transaction (or the merchant ID could be permanently displayed by a sticker affixed to a portion of the merchant device 204). (In some embodiments, the merchant identification number may be the account number that identifies the merchant's payment card account to which payment transactions are to be routed, or it may be the mobile telephone number or another mobile identifier associated with the merchant device, which would be particularly convenient in cases where the merchant device 204 is a mobile telephone.)

In some embodiments, the merchant device 204 may be capable of wirelessly transmitting the transaction information to the customer device 202. The transaction information may include line item data identifying individual product items or services, for example, included in the sales or payment transaction. The transmitting of the transaction information from the merchant device 204 to the customer device 202 may be via wireless communication such as NFC (near field communication) or alternatively may be via a mobile telephone network using text messaging or the like.

In some embodiments, the transaction information transmitted by the consumer device also includes a transaction reference number assigned by the merchant device 204 for use in subsequent communications among the originating Service Manager A computer 206, the merchant device 204, and the customer's mobile device 202. The transaction information may also include addressing information to allow the Service Manager computer 206 to contact the customer's mobile device 202. Further, the transaction information may include particulars about the merchant device 204 and/or capabilities of the merchant device (e.g., whether the merchant device is a POS terminal or a mobile phone; if the latter, what the capabilities are of the mobile phone; whether the merchant device is NFC/RFID capable). In some embodiments, another category of transaction information may include encryption- and/or authentication-related information, such as the merchant's public keys for digital signatures, and the like. Still another category of transaction information may include information that identifies the merchant's physical location, or the location of the merchant device 204.

Referring again to FIG. 2, the consumer device 202 transmits 230 a payment authorization request to Service Manager A (the entity that she is registered with). The Service Manager A computer 206 validates the consumer's credentials, and checks, based on the merchant identifier, whether the merchant is registered with Service Manager A. If the merchant is registered with Service Manager A then conventional payment card transaction processing occurs (business as usual, not shown). But if the merchant is not registered, then the Service Manager A computer 206 transmits 232 the payment information and the merchant identifier received from the consumer device along with a Service Manager identifier (SMID-A) to the MRP switch computer 210 for processing. The MRP switch computer 210 verifies SMID-A and performs a look-up of a merchant database in search of a match for the merchant identifier. If the merchant identifier is not found (no match), then the MRP switch computer 210 transmits a message back to the Service Manager A computer 206 denying the transaction, and both the consumer and merchant are notified. But if the merchant identifier is found, then the MRP switch computer 210 obtains the SMID and uniform resources locater (URL) of the Service Manager computer associated with the merchant which is, in this example, the Service Manager B computer 208 (SMID-B) so that the MRP switch computer can communicate with the Service Manager B computer 208. In some embodiments, the MRP switch computer 210 then transmits 234 enriched payment instructions to the Service Manager B computer 208 (and in some implementations wherein the MRP Switch computer 210 has adequate information, the enriched payment instructions are also transmitted 235 directly to the payment network 216). The enriched payment instructions include, in some configurations, the consumer identifier, the payment amount and a switching identifier. The switching identifier signals to Service Manager B computer 208 that the entry point for the transaction data is through the MRP switch computer 210. In some embodiments, the MRP switch computer 210 stores the enriched payment instructions for non-repudiation and data integrity purposes.

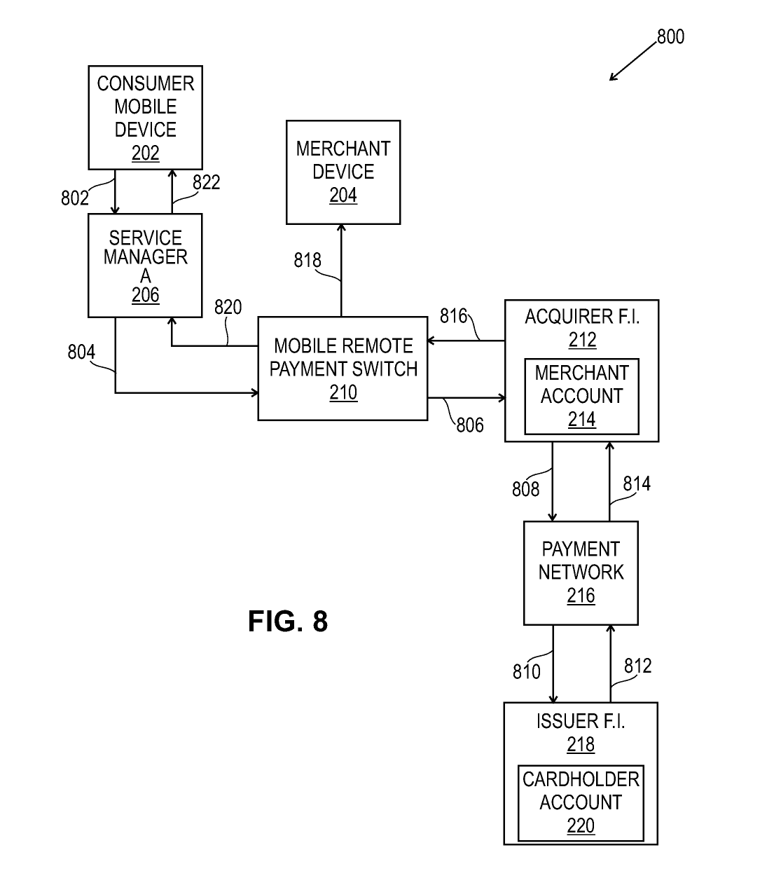

The Service Manager B computer 208 validates the payment request and the identity of MRP Switch computer 210, and then routes 236 a payment authorization request to an Acquirer FI computer 212. The Acquirer FI computer 212 routes 238 the authorization request to the payment network 216, which in turn routes 240 the authorization request to the Issuer FI 218. (In some embodiments, the payment network 216 also forwards 242 the payment authorization request to the MRP Switch computer 210.) The Issuer FI 218 then processes the payment authorization request, and if all is in order (for example, the consumer's cardholder account 220 contains an adequate credit line and/or adequate funds to cover the payment transaction) then transmits 244 a payment authorization response to the payment network 216 so that funds can be transferred to the merchant account 214 from cardholder account 220. The payment network routes 246 the payment authorization response to the Acquirer FI computer 212, which then routes 250 the payment authorization response to the Service Manager B computer 208 (the receiving Service Manager), which parses and processes the payment authorization response. (In some embodiments, the payment network 216 also forwards 248 the payment authorization response to the MRP Switch computer 210.) The Service Manager B computer 208 also notifies 252 the merchant via the merchant device 204 that payment has been authorized and/or received (along with a requested service if identified by Service Manager A, such as a top-up of minutes for the consumer's mobile device, or payment of a utility bill). (As will be explained below with regard to FIG. 8, in some embodiments the MRP Switch computer 210 can directly notify the merchant device 204 that payment has been authorized and/or received). In some embodiments, the merchant then performs fulfillment of the purchase transaction by providing the service and/or merchandise to the consumer (cardholder or subscriber).

Again referring to FIG. 2, the Service Manager B computer 208 also routes 254 the payment authorization response (i.e., the payment and fulfillment information) to the MRP Switch computer 210 along with an electronic receipt (e-Receipt). In some embodiments, the MRP Switch computer 210 then:
(a) compares the payment authorization response from the Service Manager B computer 208 to the payment authorization response from the payment network 216;
(b) stores the payment authorization response, the e-Receipt and other fulfillment information in a storage device;
(c) prepares a Draft Capture File (DCF) file (if necessary), which is used for constructing billing events; and
(d) prepares a billing events file (if necessary).

The MRP Switch computer 210 also routes 256 the payment authentication response and the e-Receipt to the Service Manager A computer 206, which notifies 258 the consumer via the consumer mobile device 202 (for example, by text message sent to the consumer's mobile telephone) that the payment transaction was successful and provides a copy of the e-Receipt.

Thus, the MRP Switch computer 210 receives information concerning a payment transaction request from an originating Service Manager, verifies the originating Service Manager, and uses a portion of the information received from the consumer device to match the merchant to a receiver Service Manager (if required). The MRP switch computer also generates enriched payment instructions and transmits them to the receiving Service Manager. In some embodiments, the MRP switch computer also stores the enriched payment instructions for non-repudiation and data integrity purposes. The MRP Switch computer 210 also receives, in some embodiments, a payment authorization response from a payment network and from the receiving Service Manager, and checks to see if they match. If there is a match, then the MRP switch computer stores the payment authorization response and an e-Receipt in a storage device, and transmits the payment authorization response and the e-Receipt to the originating Service Manager so that the originating Service Manger can notify the cardholder of the successful payment transaction by transmitting the e-Receipt to the consumer device. The present system including the MRP switch computer thus advantageously provides mobile remote payment interoperability to enable cardholders of a first closed-loop system to pay anywhere that a mobile remote payment is accepted, regardless of the cardholders' registration point, and that allows merchants registered at a second, different closed-loop system to accept mobile remote payments from consumers regardless of the merchants' registration point. The MRP system 200 also allows consumers who belong to an open-loop payment system to make payments to merchants who belong to a closed-loop payment system.

The MRP system 200 therefore provides Service Manager interoperability, allowing multiple parties who are registered with different Service Managers the ability to perform payment transactions. The MRP system also provides settlement of funds across parties, targeted specifically to either the Acquirer FI affiliated with a particular Service Manager or an Issuer FI affiliated with the Service Manager, depending on the Mobile Remote Payment domain.

From the standpoint of a user of the MRP system 200 (i.e., a consumer and/or a merchant), conducting a mobile remote payment transaction is an intuitive user experience due to the standardized integration between Service Managers and the simple integration of merchants where required. In particular, cardholder authentication is performed by the originating Service Manager (the Service Manager that the consumer has registered with), and therefore the payment transaction process is the same whether or not the merchant is registered with the originating Service Manager. Thus, the consumer experience when making a mobile remote payment to a merchant affiliated with the consumer's Service Manager is the same as when a mobile remote payment is made to a merchant who is not affiliated with the consumer's Service Manager. Such mobile remote payments are also independent of the Service Manager Domain, independent of the cardholders' registration point, and independent of the merchants' registration point. Thus, consumers and merchants need only be registered with one Service Manager.

In some embodiments, a standardized Service Manager interface (not shown) is provided, to reduce complexity and thus facilitate registration of Service Managers with the MRP Switch computer 210. In addition, in some embodiments an interoperability certification program may be implemented for Service Managers, to educate personnel responsible for updating and/or supporting Service Manager computer systems to further facilitate the registration process. Such programs involve the use of a standardized interface and provide user education, which promotes growth of Service Managers joining the mobile remote payment ecosystem.

It should also be noted that the MRP switch computer 210 receives payment transaction data that includes information concerning all of the parties to the transaction. Therefore, the MRP switch computer is in a position to provide value added services, for example, to consumers and/or to merchants. Such value added services can include, but are not limited to, offering to increase the credit line of a consumer account, offering a consumer the opportunity to join a loyalty program of a merchant, offering a merchant coupon to the consumer, and offering a discount to the consumer.

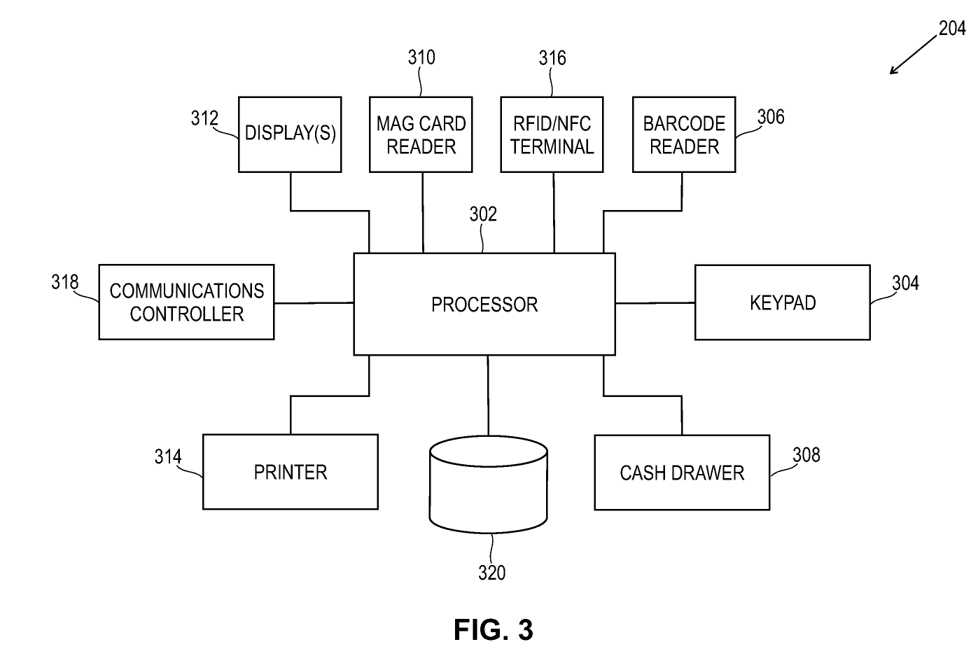

FIG. 3 is a block diagram of a POS terminal to serve (in some embodiments) as the merchant device 204 shown in FIG. 2. In some embodiments, the POS terminal 204 may be largely or entirely conventional in its hardware aspects. But the POS terminal 204 may be programmed in accordance with the aspects of the described methods to provide functionality.

The POS terminal may include a processing element (or elements) such as the processor 302 shown in FIG. 3. The processor 302 may for example be a conventional microprocessor, and may operate to control the overall functioning of the POS terminal 204. The POS terminal may also include conventional peripheral components, in communication with and/or controlled by the processor 302, such as: (a) a keypad 304 for receiving input from the human operator of the POS terminal; (b) a barcode reader 306 for reading product barcodes from products brought to the terminal for purchase; (c) a cash drawer 308 for storing cash received from customers; (d) a magnetic stripe reader 310 for reading payment card account numbers and related information from magnetic stripe payment cards; (e) one or more displays 312 for providing output (e.g., identifying products presented for purchase and their prices, indicating sales tax due, indicating transaction subtotals and totals, indicating a merchant identifier, etc.); (f) a printer 314 for printing out, for example, sales receipts or other information; (g) a wireless communication terminal and/or proximity reader 316 for exchanging wireless short range communications and/or near field communications (NFC) with, for example, a mobile telephone equipped with contactless payment device capabilities; and (h) a communication controller 318 for allowing the processor 302, and hence the POS terminal 204 to engage in communication over data networks with other devices (e.g., a Service Manager B computer 208 (see FIG. 2)). (In some embodiments, at least one of the displays 312 may be a touch screen, so as to provide an input function as well as an output function.) In some embodiments, the communication controller, or another communication device coupled to the processor 302, may be provided to allow the POS terminal 204 to transmit and receive text messages or the like via a mobile telephone network (not shown). In addition, the POS terminal 204 may include one or more memory, data storage devices and/or computer readable media (indicated collectively at 320), which may comprise any combination of one or more of a hard disk drive, RAM (random access memory), ROM (read only memory), flash memory, and the like. The data storage device(s) 320 may store software and/or firmware that instructs or programs the processor 302 and the POS terminal 204 to perform functions or provide functionality as described herein. Further, the POS terminal 204 may include one or more housings (not shown) which contain and/or support one or more of the components depicted in FIG. 3.

Those skilled in the art recognize that components 306, 310 and/or 316 may be integrated in a single unit, and may include a display and/or a touch screen to allow for user interaction.

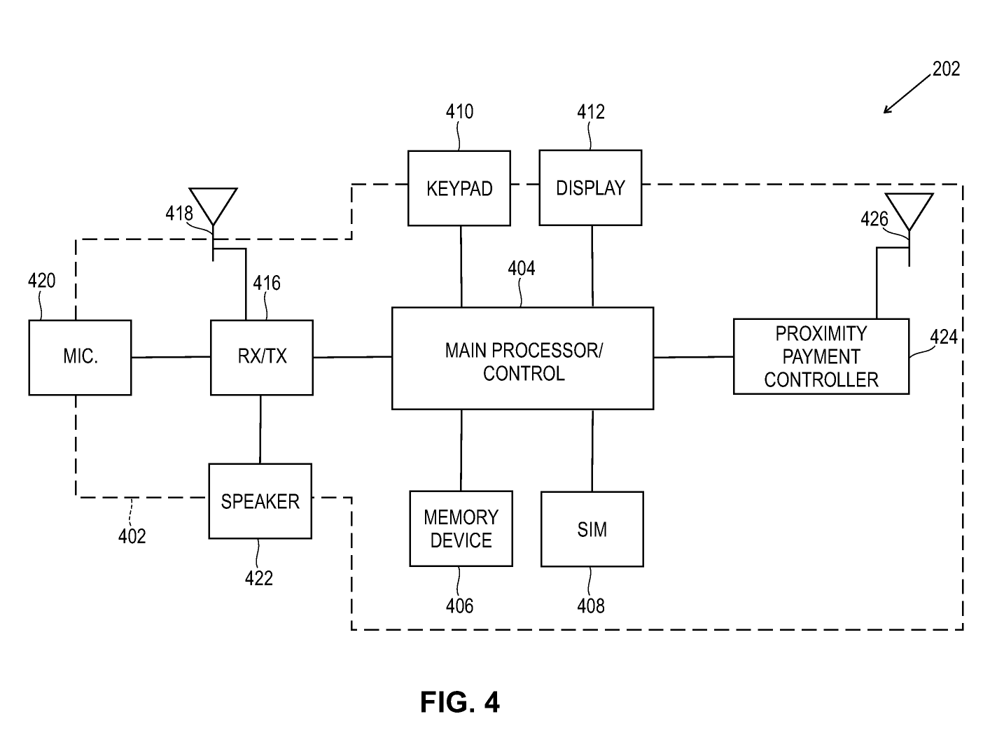

FIG. 4 is a block diagram of the components of a mobile telephone which may serve as the customer's mobile device 202 shown in FIG. 2. The mobile telephone 202 of FIG. 4 may include capabilities for functioning as a contactless payment device. In its hardware aspects the mobile telephone 202 may be entirely conventional, and indeed in its software aspects it also may be conventional, and may provide novel functionality as described herein through interaction (for example, via a conventional browser) with a web page that supports initiation of payment transactions. In other embodiments, however, novel functionality as described herein may result at least partially from software and/or firmware that instructs or programs the mobile telephone 202.

The mobile telephone 202 may include a conventional housing (indicated by dashed line 402) that contains and/or supports the mobile telephone components. The mobile telephone 202 further includes conventional control circuitry 404, for controlling over-all operation of the mobile telephone 202. The control circuitry 404 is suitably programmed to allow the mobile telephone 202 to engage in data communications and/or text messaging with other devices, and to allow for interaction with web pages accessed via browser software (not separately shown). Other components of the mobile telephone 202 which are in communication with and/or controlled by the control circuitry 404 may include: (a) one or more memory devices 406 (e.g., program and working memory, etc.); (b) a SIM (subscriber identification module) card 408; (c) a keypad 410 (or touch screen) for receiving user input; and (d) a display 412 (or a touch screen) for displaying output information to the user.

The mobile telephone 202 also includes conventional receive/transmit circuitry 416 that is also in communication with and/or controlled by the control circuitry 404. The receive/transmit circuitry 416 is coupled to an antenna 418 and provides the communication channel(s) by which the mobile telephone 202 communicates via a mobile network (not shown). The mobile telephone 202 further includes a conventional microphone 420 coupled to the receive/transmit circuitry 416, which is for receiving voice input from the user. In addition, a loudspeaker 422 is included to provide sound output to the user, and is also coupled to the receive/transmit circuitry 416.

The mobile telephone 202 may also include an integrated circuit (IC) or chipset 424 of the kind embedded in contactless payment cards. For example, the IC 424 is connected to an antenna 426 and operates so as to interact with an RFID/NFC proximity reader of a POS terminal to provide a payment card account number for a purchase transaction at the POS terminal. For example, the IC 424 may be designed and/or programmed to operate in accordance with the well-known “PayPass®” standard (promulgated by the assignee hereof) for contactless payment applications.

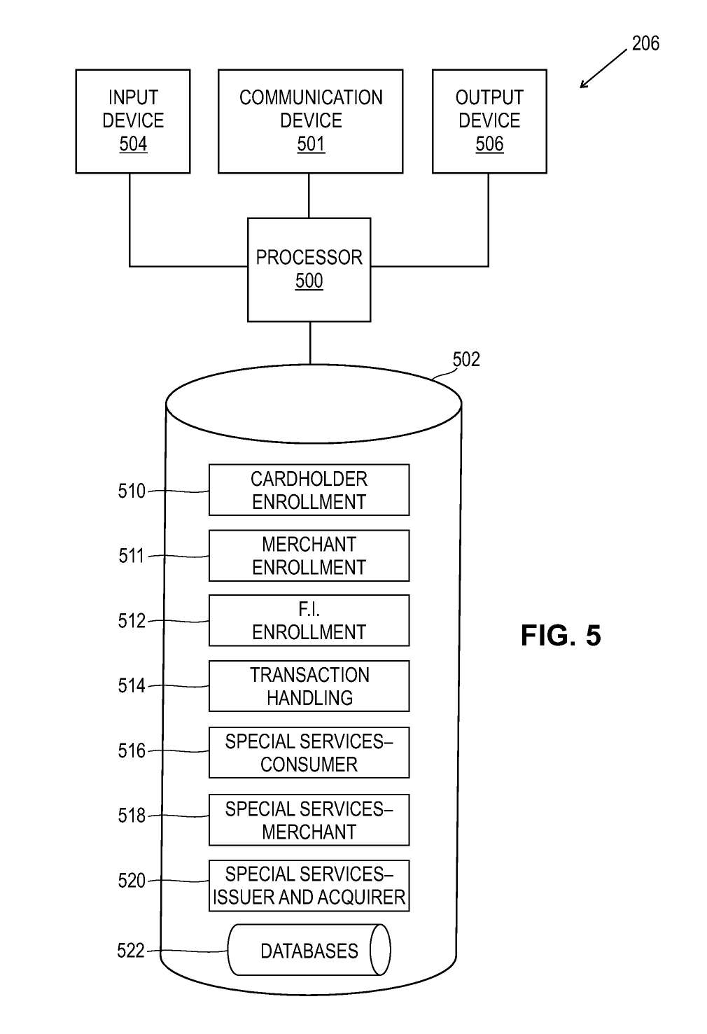

FIG. 5 is a block diagram representation of the components of an originating Service Manager computer 206 shown in FIG. 2. The Service Manager computer 206 may be conventional in its hardware aspects but may be controlled by software to cause it to operate in accordance with aspects described herein. In particular, the Service Manager computer 206 includes a computer processor 500 operatively coupled to a communication device 501, a storage device 502, an input device 504 and an output device 506. The computer processor 500 may include one or more conventional processors or microprocessors, for example, manufactured by companies such as Intel®, and it operates to execute processor-executable steps, contained in program instructions described below, so as to control the Service Manager computer 206 to provide desired functionality.

Communication device 501 may be used to facilitate communication with, for example, other devices (such as customers' mobile devices 202, merchant devices 204, and the MRP switch computer 210). Communication device 501 may, for example, have capabilities for sending and receiving messages wirelessly over mobile telephone networks, as well as engaging in data communication over conventional computer-to-computer data networks. Other types and/or forms of communication are contemplated and may be used in some embodiments.

Input device 504 may comprise one or more of any type of peripheral device typically used to input data into a computer. For example, the input device 504 may include a keyboard and a mouse. Output device 506 may comprise, for example, a display and/or a printer.

Storage device 502 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as so-called flash memory. Any type of computer-readable media may constitute the storage device 502. The storage device 502 stores one or more programs for controlling the processor 500. The programs comprise computer-readable instructions that contain processor-executable process steps for the Service Manager computer 206, including, in some cases, process steps that constitute processes provided in accordance with principles described herein.

The programs may include an application 510 that manages a process by which consumers or customers (i.e., cardholders) may register or enroll themselves and/or their mobile devices with the Service Manager computer 206. In some embodiments, the cardholder registration process may allow consumers to enroll themselves with the Service Manger A computer 206 by accessing, via their mobile devices 202, a suitable web page hosted by the Service Manager computer 206. The information gathered from the consumer during the enrollment process may include the consumer's payment card account number and mobile telephone number (or other mobile identifier). The enrollment process may also require the cardholder to select a PIN (personal identification number) to be used for security purposes in connection with payment transaction requests to be initiated by the cardholder via his or her mobile telephone 202 and via the Service Manager computer 206. Other security measures may also be put in place. In some embodiments, the Service Manager computer may cooperate with the cardholder's Issuer FI to provide security measures that assure that the individual enrolling with the Service Manager computer 206 is not an impostor.

An application 511 may also be included for managing a process by which merchants may register or enroll themselves and/or their POS terminals and/or mobile devices with the Service Manager computer 206. In some embodiments, the merchant registration process may allow merchants to enroll themselves with the Service Manger computer 206 by accessing a suitable web page hosted by the Service Manager computer 206. The information received from the merchant may include the merchant's payment account number and/or a mobile telephone number (or other mobile identifier). Security measures may be put in place to safeguard payments made to the merchant's account. In some embodiments, the Service Manager computer may cooperate with the merchant's Acquirer FI to provide security measures that assure that the merchant registering with the Service Manager computer 206 is not an impostor.

The storage device 502 may also store an application 512 for managing enrollment of Issuer FIs and/or Acquirer FIs with the Service Manager computer 206. In some embodiments, actual enrollment of Issuer FIs and/or Acquirer FIs with the Service Manager computer 206 may be performed by data entry or file downloads managed by an administrative employee of the entity that operates the Service Manager computer. This may occur after person-to-person contacts between an employee of the operator of the Service Manager computer and an employee of the Issuer FI and/or the Acquirer FI that is seeking enrollment. The FI may be enrolled as a customer Issuer FI, a merchant Acquirer FI, or in some cases, as both. In some embodiments, the FI, as part of its enrollment process, may also enroll its account holders (consumers and/or merchants) en masse with the Service Manager computer 206. Further, after enrollment of an FI, it may thereafter, from time to time, feed to the Service Manager computer enrollments of consumer and/or merchant holders of payment card accounts issued by the FI.

A payment transaction handling application 514 may also be stored by the storage device 502. In some embodiments, the transaction handling application 514 handles a payment authorization request for a purchase transaction received from a customer's mobile device. The payment authorization request may include details such as a transaction amount (the amount to be transferred from the consumer's account), a merchant identifier (for example, a POS terminal serial number, or a merchant mobile telephone number), and a customer identifier (for example, a customer mobile telephone number—included explicitly in the request or implicitly by caller ID, and/or the customer's payment card account number, and/or another code or reference that identifies the customer). The transaction handling application 514 may further include instructions to cause the processor 500 to verify or authenticate the consumer, and to look-up the merchant identifier to see if the merchant is registered with the Service Manager computer. If the merchant is not registered, the transaction handling application 514 may include instructions to cause the processor 500 to forward the payment authorization request received from the consumer device to the MRP switch computer 210 for processing. If both the consumer and merchant are registered with the Service Manager computer 206, then the transaction handling application 514 applies instructions for handling the payment authorization request in a conventional manner (business as usual).

Another application 516 that may be stored by the storage device 502 may operate in conjunction with the transaction handling application 514 to provide special value added services to individual consumer cardholders. For example, the Service Manager computer may offer or provide promotional offers, credit offers, and/or enforce restrictions on usage of the customer's payment card account. For example, there may be restrictions on a payment card account set up by a parent for his/her college student child that places certain limits on the account, such as (a) which merchants the payment card account may be used to pay (such as only at the college bookstore and/or dining hall), and/or (b) a maximum dollar amount of transactions allowed per period of time (e.g., $100.00 per week) and/or a time restriction on when that payment card account can be used (for example, only on weekdays between 9 am and 8 pm). The application 516 may also include instructions to instruct the processor to enforce such restrictions and/or to transmit special offers, for example, merchandise discounts or loyalty rewards for certain predefined types or classes of consumers in the name of one or more registered merchants. In addition, the application 516 may include instructions permitting the consumer to use a virtual card number instead of an actual payment card account number for security purposes (for example, if the consumer utilizes her mobile telephone virtual wallet account, she may be permitted to transmit a virtual card number to the merchant's POS terminal that is later mapped by the card payment system to a payment card account during processing).

In addition, in some implementations, the applications 518 and 520 provide, respectively, special value added services to merchants and to Issuer and Acquirer FIs. Examples of such special value added services include transmitting special offers to consumers on behalf of an Issuer (for example, transmitting an offer to a consumer's mobile phone for a business card account with a low interest rate), and/or transmitting an offer to a merchant on behalf of an Acquirer FI to provide loyalty points or other rewards if consumers utilize a particular type or brand of payment card account during a defined time period.

Reference numeral 522 identifies one or more databases that are maintained by the Service Manager computer 206 on the storage device 502. These databases may include, but are not limited to, a consumer (cardholder) database, a merchant database, an Issuer FI database, an Acquirer FI database, a transaction database, a special offers database (with entries that may be linked to specified merchants), a merchants loyalty rewards program database, and the like.

The application programs of the Service Manager computer 206 as described above may be combined in some embodiments, as convenient, into one, two or more application programs. In some embodiments, the application programs may be composed of one or more program modules some of which may be shared, for example, among or by two or more applications. Moreover, the storage device 502 may store other programs, such as one or more operating systems, device drivers, database management software, web hosting software, and the like.

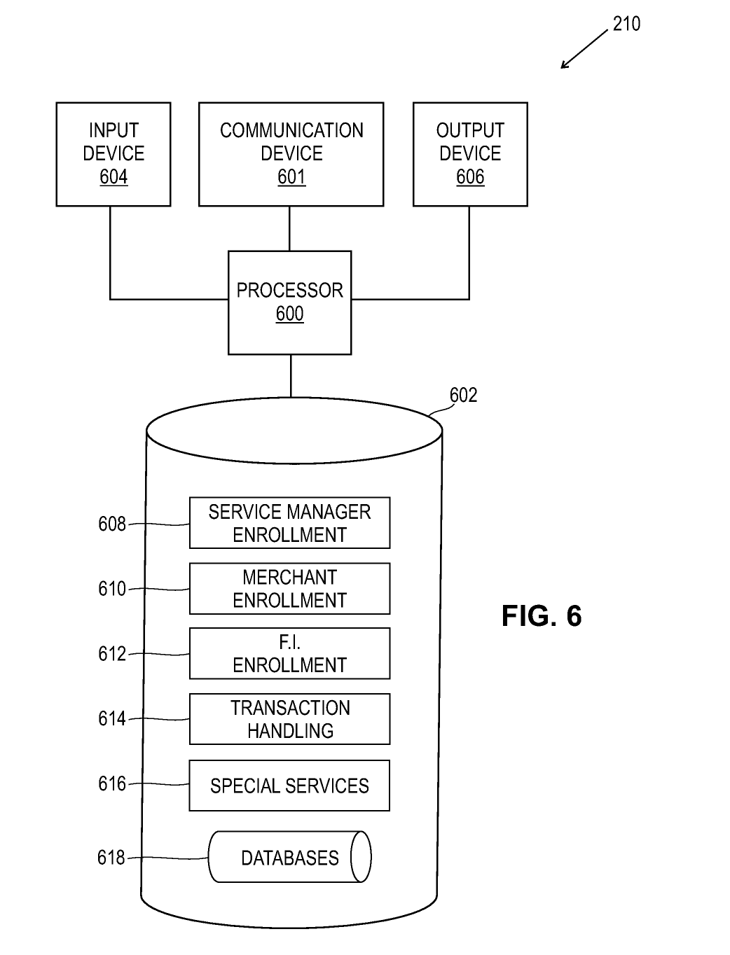

FIG. 6 is a block diagram representation of the components of a MRP switch computer 210 shown in FIG. 2. The MRP switch computer 210 may be conventional in its hardware aspects but may be controlled by software to cause it to operate in accordance with aspects described herein. In particular, the MRP switch computer includes a computer processor 600 operatively coupled to a communication device 601, a storage device 602, an input device 604 and an output device 606. The computer processor 600 may include one or more conventional processors or microprocessors, for example, manufactured by companies such as Intel®, and it operates to execute processor-executable steps, contained in program instructions described below, so as to control the MRP switch computer 210 to provide desired functionality.

Communication device 601 may be used to facilitate communication with, for example, other computers and/or devices (such as the Service Manager computers 206 and/or 208), and in some embodiments, with the payment network 216, and/or the merchant device 204 and/or an Acquirer FI computer). Communication device 601 may, for example, be capable of sending and receiving messages wirelessly over mobile telephone networks, as well as engaging in data communication over conventional computer-to-computer data networks. Other types and/or forms of communication are contemplated and may also be utilized in some embodiments.

Input device 604 may comprise one or more of any type of peripheral device typically used to input data into a computer. For example, the input device 604 may include a keyboard and a mouse for use by a systems operator to, for example, perform updates and/or system maintenance. Output device 606 may comprise, for example, one or more displays and/or printers.

Storage device 602 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as flash memory devices. Thus, any suitable type of computer-readable media may constitute the storage device 602. The storage device 602 is configured to store one or more application programs for controlling the processor 600. The programs comprise computer-readable instructions that contain processor-executable process steps for the MRP switch computer 210, including, in some cases, process steps that constitute processes provided in accordance with principles described herein.

The programs stored in storage device 602 may include an application 608 that manages a process by which Service Managers may register or enroll themselves. In some embodiments, the Service Manager registration process may include permitting Service manager computers to access a suitable web page hosted by the MRP switch computer 210 and to receive required data. The information gathered by MRP switch computer during the enrollment process may include Service Manager identification data, a list of consumers and/or merchants registered with the Service Manager, and a list of Issuer FIs and/or Acquirer FIs associated with the consumers and/or merchants. The enrollment process may also require the Service Manager to select a SMIN (Service Manager identification number) to be used for security purposes in connection with payment transaction requests forwarded from the Service Manager computer to the MRP switch computer for processing, and may also be used for other purposes, such as when the Service Manager computer provides a data update to include information of newly enrolled consumers and/or merchants, and/or provides data regarding removal of consumers and/or merchants who no longer wish to be registered with the Service Manager. Other security measures may also be put in place.

In some embodiments, an application 610 may also be included in the storage device 602 for managing a process by which merchants may directly register or enroll themselves and/or their POS terminals and/or their mobile devices with the MRP switch computer 210. In some embodiments, the merchant registration process may allow merchants to enroll themselves with the MRP switch computer 210 by accessing a suitable web page hosted by the MRP switch computer or by other means such as by filling out and submitting registration forms that include all the necessary data. The information or data received from the merchant may include, but is not limited to, the merchant's payment account number, and/or a device identifier, and/or a mobile telephone number (or other mobile identifier). Security measures may be put in place to safeguard payments and/or payment data concerning payments made to the merchant's account. In some embodiments, the MRP switch computer may have the data required for cooperating with the merchant's Acquirer FI to provide security measures that assure that the merchant registering with the MRP switch computer 210 is not an impostor.

In some embodiments, the storage device 602 may also store an application 612 for managing enrollment of Acquirer FIs with the MRP switch computer 210. The actual enrollment of an Acquirer FIs with the MRP switch computer 210 may be performed, in some embodiments, by data entry or file downloads managed by an administrative employee of the entity that operates the MRP switch computer. This may occur after person-to-person contacts between an employee of the operator of the MRP switch computer and an employee of the Acquirer FI that is being enrolled or registered. The Acquirer FI may be enrolled as a merchant Acquirer FI and, in some embodiments, the Acquirer FI as part of the enrollment process, may also enroll its merchant account holders en masse with the MRP switch computer 210. Further, after enrollment of an Acquirer FI, it may thereafter, from time to time, feed to the MRP switch computer additional enrollment information concerning new merchant registrations and merchant account identifiers for their merchant payment card accounts issued by the Acquirer FI. The Acquirer FI may also, from time to time, provide an update to the enrollment data concerning merchants who are no longer registered with the Acquirer FI.

Another application that may be stored by the storage device 602 is for handling payment transactions and is indicated by reference numeral 614 in FIG. 6. In some embodiments, the transaction handling application 614 is configured to handle a payment authorization request for a mobile remote payment transaction received from an originating Service Manager computer. The request may include details from a consumer device that includes data concerning a transaction amount (the amount to be transferred from a consumer's account), a merchant identifier (for example, a POS terminal serial number, or a merchant mobile telephone number), and a customer identifier (for example, a customer mobile telephone number—included explicitly in the request or implicitly by caller ID, or the customer's payment card account number, or another code or reference that identifies the customer). The transaction handling application 614 may further include instructions to cause the processor 600 to verify or authenticate the originating Service Manager, and to look-up the merchant identifier to see if the merchant is registered with a second Service Manager. If a match is found, the transaction handling application 614 may further include instructions to cause the processor to generate and to transmit enriched payment instructions to the second Service Manager computer, and in some embodiments to the payment network 216 (see FIG. 2) directly. (In some embodiments, the MRP switch computer stores the enriched payment instructions for non-repudiation and data integrity purposes.) In addition, in some embodiments the transaction handling application 614 may further include instructions to cause the processor 600 to receive a payment authorization response and an e-Receipt from the second Service Manager computer, and to route the e-Receipt to the originating Service Manager computer. In some embodiments, the transaction handling application 614 may further include instructions to cause the processor 600 to store the payment authorization response, the e-Receipt and other fulfillment information, and to prepare billing events for later processing. However, in some other embodiments, the transaction handling application 614 may further include instructions to cause the processor 600 to transmit the payment authorization response, the e-Receipt and other fulfillment information directly to, for example, a merchant device.

In some other embodiments, the transaction handling application 614 may include instructions to cause the processor 600 to verify an originating Service Manager, look-up a merchant identifier and generate an ISO-8583 authorization request, look-up a requested merchant identifier and identify an Acquirer FI associated with the merchant, construct payment instructions that include a switching identifier and a payment gateway identifier, submit an ISO-8583 payment authorization request to that Acquirer FI, and receive and process the authorization response from the Acquirer FI. The term “ISO-8583” defines a message format and a communication flow so that different systems can exchange payment transactions. For example, the majority of transactions made by customers in retail stores use the ISO-8583 messaging format at some point in the communication chain, and in particular, the MasterCard® network bases authorization communications on the ISO 8583 standard (as do many other institutions and networks).

Referring again to FIG. 6, in some embodiments the application 614 also includes instructions to instruct the processor 600 to prepare a draft capture file (DCF), prepare billing events, create a digital receipt, transmit a notification to the merchant regarding payment with transaction details, and route the authorization response and e-Receipt to the originating Service Manager computer.

Another application 616 that may be stored by the storage device 602 operates in conjunction with the transaction handling application 614 to provide special value added services. For example, the MRP switch computer 210 may offer or provide promotional offers and/or credit offers associated with the merchant to the customer (in some cases along with the e-Receipt), and/or may provide special value added services to merchants and to Acquirer FIs.

Reference numeral 618 identifies one or more databases that are maintained by the MRP switch computer 210 on the storage device 602. Among these databases may be a Service Manager database, a merchant database, an Issuer FI database, an Acquirer FI database, and a transaction database.

The application programs of the Mobile Remote Payment Switch computer 210 described above may be combined in some embodiments, as convenient, into one, two or more application programs. In some embodiments, the application programs may be composed of one or more program modules some of which may be shared, for example, among or by two or more applications. In addition, the storage device 602 may store other programs, such as one or more operating systems, device drivers, database management software, web hosting software, and the like.

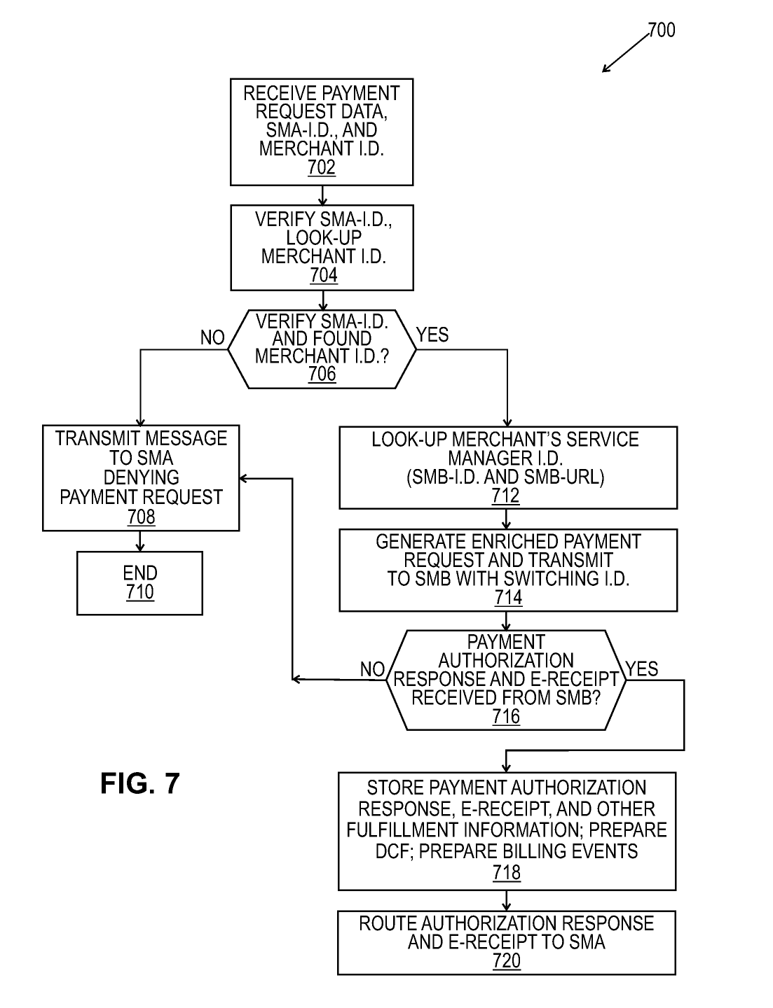

FIG. 7 is a flow chart that illustrates a process 700 that may be performed by a MRP switch computer 210 in connection with a mobile remote payment transaction handled by the system 200 shown in FIG. 2. In step 702, the MRP switch computer 210 receives payment request data from an originating Service Manager computer (SMA) that includes an originating Service Manager identifier (SMA-ID) and a merchant ID. Next, in step 704, the Mobile Remote Payment Switch computer verifies the originating Service Manager by, for example, matching the SMA-ID to an identifier in a Service Manager database, and looks-up the merchant ID. If the SMA-ID is not found (i.e., cannot be verified) and/or the merchant ID cannot be found in step 706, then the Mobile Remote Payment Switch computer transmits 708 a message to the originating Service Manager (SMA) denying the payment request, and then the process ends 710. In some embodiments, the message denying the payment request includes a failure message that distinctly identifies the reason(s) for the failure, for example, one of the merchant ID or the SMA-ID (or both) are invalid.

But if, in step 706, the MRP switch computer verifies the originating Service Manager (i.e., a match is found to the SMA-ID in the Service Manager database), and the merchant ID is found in a Merchant Database, then the MRP switch computer looks-up 712 a receiving identifier for the receiving Service Manager associated with the merchant ID (SMB-ID), along with the Service Manager Uniform Resources Locator (URL) information. The MRP switch computer next generates 714 enriched payment instructions and transmits them to the receiving Service Manager (SMB), along with a Switching Identifier (Switching-ID) that informs the receiving Service Manager (SMB) that the entry point is through the MRP switch computer. In some embodiments, the MRP switch computer also stores the enriched payment instructions for non-repudiation and data integrity purposes. Next, if a payment authorization response and an e-Receipt are received 716 from SMB, then the MRP switch computer stores the payment authorization response, the e-Receipt and other fulfillment information, and prepares billing events. In some embodiments, the MRP switch computer validates the payment authorization response sent by receiving Service Manager validates the digital receipt to ensure the purchase amount, the payment information, the merchant ID and that the date-timestamp matches the original payment authorization request. In addition, the MRP switch computer may store a copy of payment authorization response sent by the receiving Service Manager for non-repudiation and data integrity purposes, including the digital receipt, and then log the event and store response information. In some embodiments, the MRP switch computer also prepares a Draft Capture File (DCF), which is used for constructing billing events and to provide for payment reconciliation (which is especially useful in some embodiments wherein the MRP Switch computer transmits the DCF directly to an Acquirer FI). The MRP switch computer then routes the payment authorization response and the e-Receipt to the originating Service Manager (SMA). In addition, in some embodiments, the MRP switch computer stores an acknowledgement response (and any information) from the originating Service Manager A computer to ensure non-repudiation. The originating Service Manager (SMA in the examples above) then notifies, in some embodiments, the consumer of the successful payment transaction by transmitting the e-Receipt to the consumer device.

Referring again to FIG. 7, if in step 716 the MRP switch computer does not receive a payment authorization response and an e-Receipt from the SMB, then a message is transmitted 708 to the originating Service Manager (SMA) denying the payment request, and then the process ends 710. In some embodiments, in this case the message denying the payment request includes a failure message that distinctly identifies the reason(s) for the failure, for example, an e-Receipt was not received or the payment request was denied by the Issuer FI. According to one possible feature of the above described process 700, and although not indicated in FIG. 7, the process could have a time-out feature that causes the MRP switch computer to abort the payment transaction, for example, if the payment authorization response is not received within a predetermined waiting period.

FIG. 8 is a block diagram that illustrates another embodiment of a mobile remote payment transaction system 800. In this implementation, the MRP switch computer 210 operates as a payment gateway to facilitate payment transactions. As in FIG. 2, a consumer having a consumer mobile device 202 wishes to purchase an item from a merchant having a merchant device 204 (which may be a point-of-sale (POS) terminal or another device, such as a mobile telephone). Thus, the consumer uses her mobile device to transmit transaction information to a Service Manager A computer 206 (the originating Service Manger) that includes, in some embodiments, a customer identifier, a payment amount and a merchant identifier. (The consumer has previously registered her consumer mobile device for mobile remote payments with the Service Manager A.) Service Manager A may be affiliated with a first mobile network operator (MNO), whereas the merchant may be registered with a different Service Manager that may be affiliated with a second MNO.

In this MRP system 800 embodiment, the Service Manager A computer 206 (the originating Service Manager) recognizes and authenticates the consumer mobile device 202, but does not recognize the merchant information or merchant device 204. Thus, the MRP switch computer 210 is configured to perform the role of a payment gateway, wherein the MRP switch computer will submit payment authorization requests directly to a participating Acquirer FI and provide the necessary functionality to conduct the mobile remote payment transaction so that consumers can utilize their mobile devices to make mobile remote payments regardless of which Service Manager he or she is registered with, and regardless of the Service Manager that the merchant is registered with. As mentioned above, the MRP switch computer 210 may be owned and/or operated by a payment card organization (e.g., the assignee hereof).

Referring to FIG. 8, the mobile remote payment switch computer 210 is operable to communicate with the Service Manager A computer 206, the merchant device 204 and an Acquirer FI 212 holding a merchant account 214. The Acquirer FI 212 is configured to communicate with a payment network 216, which may be the Banknet™ system mentioned above that is operated by the assignee hereof. The payment network 216 is operable to communicate with both the Acquirer FI 212 and the Issuer FI 218 (that issued the cardholder account 220 associated with the consumer device 202 of the consumer).

In FIG. 8, arrows 802 to 822 trace the path of a payment transaction. As mentioned above, in some embodiments the consumer (who is the cardholder or the financial account holder) initiates a payment request by selecting and then transmitting data stored in her mobile device regarding a payment account, or by entering and then transmitting a consumer identifier from her mobile phone 202. (The consumer identifier can be associated with a credit card number, debit card number or some other financial account number.) In some embodiments, the consumer also enters a payment amount for an item or service, and a merchant identifier. (In some other embodiments, the payment amount and merchant identifier are communicated by the merchant device to the consumer device.) The consumer device then transmits 802 a payment authorization request to Service Manager A (the entity that she is registered with) that includes the consumer and merchant identifiers and a purchase price.

The Service Manager A computer 206 authenticates and/or verifies the consumer's credentials, and checks to see if the merchant is registered with Service Manager A. If the merchant is registered with Service Manager A then a conventional transaction payment processing occurs (business as usual, not shown). But if the merchant is not registered, then the Service Manager A computer 206 transmits 804 the payment information and the merchant identifier received from the consumer device 202 along with a Service Manager identifier (SMID-A) to the MRP switch computer 210 for processing. The MRP switch computer verifies and/or validates the SMID-A and then accesses one or more databases to look up the merchant identifier and to look-up the Acquirer FI associated with the merchant. If the merchant identifier and/or the Acquirer FI information are not found, then the MRP switch computer 210 transmits a message back to the Service Manager A computer 206 denying the transaction.

But if the merchant identifier is found along with the Acquirer FI information, then the MRP switch computer 210 generates enriched payment instructions that includes switching and payment gateway indicators, and prepares an ISO-8583 payment authorization request. The MRP switch computer 210 then routes 806 the ISO-8583 payment authorization request to the Acquirer FI 212 which includes the enriched payment instructions. In some embodiments, the enriched payment request data includes the consumer identifier, the payment amount and a switching identifier (that signals the entry point to Service Manager A 206 is through the MRP Switch computer 210). Also in some embodiments, the MRP switch computer stores the enriched payment instructions for non-repudiation and data integrity purposes. Next, the Acquirer FI computer 212 routes 808 the payment authorization request to the payment network 216, which in turn routes 810 the payment authorization request to the Issuer FI 218 which holds the consumer's cardholder account 220. The Issuer FI 218 then processes the payment request, and if all is in order (for example, the consumer's cardholder account 220 contains an adequate credit line and/or funds to cover the payment transaction), transmits 812 a payment authorization response to the payment network 216 so that funds can be transferred to the merchant account 214. The payment network routes 814 the payment authorization response to the Acquirer FI computer 212, which then routes 816 the payment authorization response to the MRP Switch computer 210. Upon receiving the payment authorization response, the MRP Switch computer 210 creates a digital receipt and notifies 818 the merchant device 204 that payment was made so that the merchant can fulfill his or her obligation to the consumer, which means that the merchant consummates the purchase transaction by providing the service and/or merchandise to the consumer (cardholder or subscriber). The MRP switch computer 210 also routes 820 the digital receipt to the Service Manager A computer 206, which transmits 822 the digital receipt to the consumer device 202 so that the consumer knows that payment was made successfully.

However, according to one possible feature of the above described process, and although not indicated in FIG. 8, the process could have a time-out feature such that the MRP switch computer aborts the payment transaction if the payment authorization response is not received within a predetermined waiting period. In such a case, a message may be transmitted from the MRP switch computer to the merchant device 204 and to the originating Service Manager computer 206 that notifies them that the payment transaction was unsuccessful.

In summary, the MRP switch computer 210 receives information concerning a payment authorization request from an originating Service Manager, verifies the originating Service Manager, uses a portion of the received information to match a merchant to an Acquirer FI, and enriches the payment instructions and transmits them to the Acquirer FI. In some embodiments, the MRP switch computer also stores the enriched payment instructions for non-repudiation and data integrity purposes. The MRP Switch computer 210 also receives a payment authorization response from the Acquirer FI and provides a digital receipt to the merchant device and to the originating Service Manager (for routing to the consumer device). Thus, the present MRP system including the MRP switch computer advantageously provides mobile remote payment interoperability to enable cardholders to pay merchants anywhere that a mobile remote payment is accepted, regardless of the cardholders' registration point, and that allows merchants to accept the mobile remote payment regardless of the merchant's registration point.

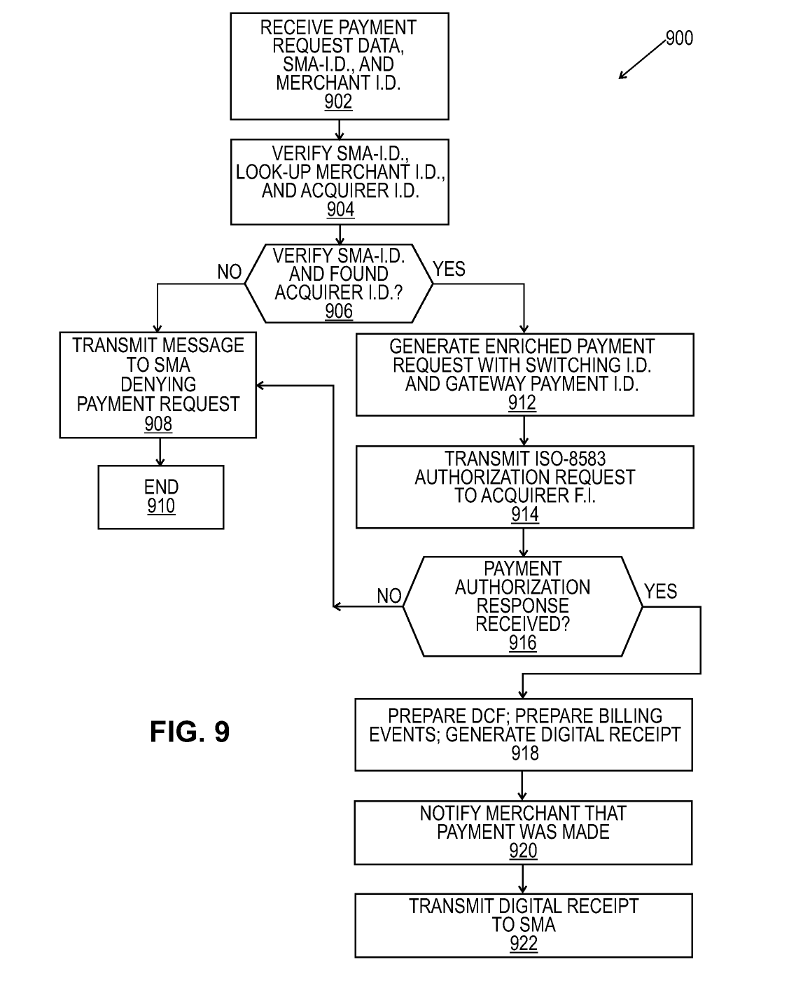

FIG. 9 is a flow chart that illustrates an embodiment of a process 900 that may be performed by a MRP switch computer 210 in connection with a mobile remote payment transaction handled by the MRP system 800 shown in FIG. 8. In step 902, the MRP switch computer 210 receives payment request data from an originating Service Manager computer (SMA) that includes an originating Service Manager identifier (SMA-ID) and a merchant ID. The MRP switch computer then verifies 904 the originating Service Manager by, for example, matching the SMA-ID to an identifier in a Service Manager database, and also looks-up the merchant ID. If the SMA-ID is not found (i.e., cannot be verified) and/or the merchant ID cannot be found in step 906, then the MRP switch computer transmits 908 a message to the originating Service Manager (SMA) denying the payment request, and then the process ends 910. In some embodiments, the message denying the payment request includes a failure message that distinctly identifies the reason(s) for the failure, for example, one of the merchant ID or the SMA-ID (or both) are invalid.

But if, in step 906, the MRP switch computer verifies the originating Service Manager (i.e., a match is found to the SMA-ID in the Service Manager database), and the merchant ID is found in a Merchant Database, then the MRP switch computer generates an enriched payment request. The enriched payment request includes a switching identifier for an Acquirer FI, and a payment gateway identifier to signal that the MRP switch computer is performing a payment gateway function. The MRP switch computer then transmits 914 an ISO-8583 authorization request to the Acquirer FI. In some embodiments, the MRP switch computer also stores the enriched payment instructions for non-repudiation and data integrity purposes.

Next, if a payment authorization response is received 916 from the Acquirer FI, then the MRP switch computer prepares 918 a draft capture file, a billing events file, and creates a digital receipt of the purchase. In some embodiments, the MRP switch computer also stores a copy of the payment authorization response for non-repudiation and data integrity purposes and logs the event. Next, the MRP switch computer notifies 920 the merchant device that payment has been made (or will be credited to the merchant account), and then transmits 922 the digital receipt to the originating Service Manager A computer. In some embodiments (not shown), the Service Manager A computer then routes the digital receipt to the consumer device. Also, in some embodiments, the MRP switch computer stores the payment authorization response, the digital receipt and other payment transaction information (not shown). In addition, in some embodiments, the MRP switch computer stores an acknowledgement response (and any information) from the originating Service Manager A computer to ensure non-repudiation.

Referring again to FIG. 9, if in step 916 the MRP switch computer does not receive a payment authorization response, then a message is transmitted 908 to the originating Service Manager (SMA) denying the payment request, and then the process ends 910. In some embodiments, in this case the message denying the payment request includes a failure message that distinctly identifies the reason(s) for the failure, for example, an e-Receipt was not received or the payment request was denied by the Issuer FI. According to one possible feature of the above described process 900, and although not indicated in FIG. 9, the process could have a time-out feature that causes the MRP switch computer to abort the payment transaction if the payment authorization response is not received from the Acquirer FI within a predetermined waiting period.

With regard to the mobile remote payment transaction methods described herein, liability for fraudulent charges and/or for chargebacks depends on the mobile remote payment authentication domain. In particular, if a consumer (cardholder) is authenticated by a Service Manager operating in an issuer domain, then the Issuer FI loses fraud-related chargeback rights. But if the consumer (cardholder) is authenticated by a Service Manager operating in the acquirer domain, the Issuer FI retains fraud-related chargeback rights. In some embodiments, the MRP switch computer polices the liability functions in case of chargebacks. In addition, in order to maintain consistency between Service Managers and payment systems, all merchant identifiers are issued and governed by the MRP switch computer as MRP Merchant IDs, and the Service Managers are responsible for mapping between the MRP Merchant IDs and the Acquirer FI assigned merchant ID. In addition, with regard to the system 800 of FIG. 8, the MRP switch computer 210 also must map between the MRP Merchant IDs and the Acquirer FI assigned merchant ID. The MRP switch computer assigns and maintains globally unique merchant IDs to maintain consistency between all mobile remote payment schemes.

The MRP switch computer provides interoperability between Service Managers that may be serving a mobile network operator (MNO) in a 3-party model (close-loop) or serving in a traditional payment 4-party model (open-loop). In summary, the MRP switch computer switches payments between close-loop to close-loop and between close-loop to open-loop systems. In some embodiments, the MRP switch computer receives input from originating Service Managers that initiate payment authorization requests and routes the payment authorization requests to receiving Service Managers for further processing (a dual Service Manager model). In other embodiments, the MRP switch computer receives input from an originating Service Manager and makes the payment authorization request directly to an Acquirer FI (a payment gateway model).

In some embodiments, the MRP switch computer includes a MRP Directory Server containing meta-data information concerning all the Service Managers and merchants, along with its associated data as collected by management modules. The MRP Directory Server is the master system of record for Service Managers and merchants and other associated information. Information collected from management modules is stored and structured in this MRP Directory Server, which may also be used for meta-data lookup as required to perform MRP switching or settlement, or as needed by authorized components of the MRP system. For security reasons, the data collected in the MRP Directory Server is not exposed directly to entities outside the MRP payment system.

The mobile remote payment systems and methods disclosed herein are flexible and economical, as the banking relationships required by the participants (consumers, merchants and Service Managers) can be established and maintained at relatively low cost. Thus, the economic barriers to adoption are minimized. In addition, the disclosed systems are open systems, in the sense that the parties (consumers, merchants and financial institutions) need not have a relationship with the same Service Managers, financial institutions or MNOs, but need only have low level banking relationships with respective FIs that belong to a widespread payment card system such as that organized by the assignee hereof. In addition, the parties to a payment transaction (typically consumers and merchants and/or service providers) do not need to even use the same mobile network operator (MNO).

In some embodiments described herein, the request for a payment transaction may explicitly include the customer's payment card account number, the merchant's payment card account number and the amount of the requested payment transaction. In other embodiments, the customer and/or the merchant may be identified by their respective mobile telephone numbers, or in another manner apart from their payment card account numbers. If so, a component computer associated with the overall MRP system may translate the customer's mobile telephone number (whether explicitly or implicitly (by caller ID) included in the request) into the customer's payment card account number, and another component may function to translate the merchant's mobile telephone number into the merchant's payment card account number so that the payment authorization request and any payment authorization response can be routed correctly.

In other embodiments, and assuming that the customer's mobile device is a mobile camera-phone, the authentication procedure may call for the customer to use the mobile device to take his/her picture and transmit it to the authenticating component computer so that it can be compared to a pre-stored picture that was previously filed.

In some embodiments, value added information, such as demographic information about customers as collected by the customers' mobile network providers, may be provided to merchants and/or to Service Managers for example, for market research purposes. Other types of value added data analysis are contemplated for use in the described systems. For example, if the customer requests a payment transaction at a time when the customer has exceeded his/her credit limit or has depleted his/her debit card account, the customer's Issuer FI (or the Service Manager acting on behalf of the customer's Issuer FI) may respond to the payment authorization request with a message (for example, sent to the customer's mobile device 202) offering to make an overdraft or credit facility available to the customer. If the customer responds (for example, via text message) in the affirmative then a payment authorization response can be generated so that the payment transaction can be honored.

According to another special service, the customer's Issuer FI and/or the Service Manager may present the customer (via a message or messages transmitted to the mobile device 202) with one or more promotional offers and/or virtual coupons which the customer may avail himself/herself with to fund at least a portion of a payment transaction. For example, based on the identity of the merchant an originating Service Manager may offer on behalf of the merchant that a portion of the payment transaction will be funded by the merchant if the customer enrolls in the merchant's customer loyalty program.

To a large extent, the novel aspects of the MRP systems and methods for handling payment transactions as proposed herein have been described in the context of face-to-face retail sales of goods between a consumer and a merchant. However, a considerable number of other novel applications for facilitating mobile remote payment transactions are also contemplated. For example, mobile remote payment transactions may also be requested via a consumer's mobile device to settle payments for services such as automobile rentals, taxi rides, airline and train fares, personal care services (e.g., hair salon services, manicures, personal training, etc.), health club and gym fees, medical and dental services, dry cleaning, home renovations, cultural and sporting event ticketing, periodical subscriptions, museum entrance fees, and the like. It should thus be understood that, in the context of mobile remote payment transactions, the merchant and/or service provider need not be face-to-face with the customer. Thus payment transactions may be initiated by the customer to pay for, for example, mobile telephone air time or for online orders. For example, in the case where the customer's mobile device is a PDA, the customer may access an online store, which may push the transaction information, upon checkout, to the customer's mobile device (possibly via a Service Manager computer 206). The customer's mobile device may then request a payment transaction to settle the online purchase. The online store may first wait to receive confirmation via its Acquirer FI that the payment transaction is or will be completed before proceeding to fulfill the customer's order.

In addition, while many of the above examples of payment transactions implemented with the disclosed mobile remote payment systems and methods have been illustrated with regard to consumer purchase examples, similar mobile remote payment transactions may occur with respect to business transactions. For example, a company representative may utilize a mobile device to purchase supplies by using a commercial credit or debit cards. For example, a building contractor may utilize his company cell phone to purchase building materials from a lumber yard with a company credit or debit card account. Thus, a customer or consumer, as referred to herein and in the appended claims, need not be an individual consumer or purchaser.

In addition to other advantages, including those described above, the system architectures shown (in FIGS. 2 and 8) may also allow the Service Managers and/or the financial institutions (such as Acquirer FIs associated with merchants) to set policies for personalizing and/or customizing service practices. For example: (a) credit offers may be made only to certain customers and/or in connection only with certain kinds of transactions; and (b) whether additional authentication procedures are required may be determined according to predetermined rules on a customer-by-customer and/or on a transaction-by-transaction basis. More complex rules may also determine when payment authentication is not required, including for example rules based on recent transaction history for a cardholder account.

It will be understood that communications among the customer's mobile device 202 and/or the merchant device 204 and/or other components in the system may be carried, at least in part, via a conventional mobile telephone network, which is not explicitly shown in the drawings.

In some embodiments, the customer's mobile device triggers the merchant device to download the transaction information to the customer's mobile device by transmitting a suitable signal to the merchant device, e.g., by NFC. Correspondingly, the merchant device may download the transaction information to the customer's mobile device in response to receiving such a signal from the customer's mobile device.

The flow charts and descriptions thereof herein should not be understood to prescribe a fixed order of performing the method steps described therein. Rather the method steps may be performed in any order that is practicable.

As used herein and in the appended claims, an “information message” includes a text message or any other message sent to or from a mobile device to transmit information other than audible or visual information.

As used herein and in the appended claims, the term “payment card account” includes a credit card account or a deposit account that the account holder may access using a debit card. The term “payment card account number” includes a number that identifies a payment card account or a number carried by a payment card, or a number that is used to identify an account in a payment system that handles debit card and/or credit card transactions or to route a transaction in a payment system that handles debit card and/or credit card transactions. The term “payment card” includes a credit card or a debit card (including a pre-paid debit card). The term “payment card account” also includes an account to which a payment card account number is assigned. Thus a payment card account may include an account to which payment transactions may be routed by a payment system that handles debit card and/or credit card transactions, even if the account in question is not eligible to be charged for purchase transactions or other transactions. A payment card account may also include an account from which payment transactions may be routed by a payment system that handles debit card and/or credit card transactions, even if the account in question is not customarily used, or is not eligible, to be charged for purchase transactions.

It should also be understood that account numbers that identify the merchants' or other recipients' payment card accounts herein may be in a format and in an account number range that allow payment transactions to be routed to the accounts in question. In addition, such accounts may, but need not, be operable for charging purchase transactions to such accounts.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
receiving, by a mobile remote payment (MRP) switch computer from an originating service manager computer, a payment authorization request that comprises payment data, an originating service manager identifier, and a merchant identifier of a merchant;
verifying the originating service manager identifier;
determining that the merchant is affiliated with the receiving service manager;
generating, by the MRP switch computer, enriched payment instructions that include a switching identifier;
transmitting the enriched payment instructions to a receiving service manager computer of the receiving service manager;
receiving, by the MRP switch computer, a payment authorization response from the receiving service manager computer that includes an electronic receipt; and
transmitting the payment authorization response and the electronic receipt to the originating service manager computer.

2. The method of claim 1, further comprising transmitting, by the originating service manager computer, the electronic receipt to a consumer device.

3. The method of claim 1, further comprising transmitting, by the receiving service manager, the electronic receipt to a merchant device.

4. The method of claim 1, further comprising providing, by the MRP switch computer, value added services to at least one of the consumer, the merchant, and a financial institution.

5. The method of claim 1, further comprising receiving, by the MRP switch computer, an acknowledgement message from the originating service manager computer acknowledging receipt of the electronic receipt.

6. The method of claim 5, further comprising storing the acknowledgement message in a storage device of the MRP switch computer to ensure non-repudiation.

7. The method of claim 1, further comprising:
receiving a payment authorization response from a payment network computer;
determining that the payment authorization response from the payment network computer matches the payment authorization response from the receiving service manager computer; and
storing the payment authorization response and the electronic receipt in a storage device.

8. The method of claim 1, wherein the enriched payment instructions further comprises at least one of an originating service manager identifier and a MRP merchant identifier.

9. The method of claim 1, further comprising, subsequent to determining the receiving service manager, storing the enriched payment instructions for non-repudiation and data integrity purposes.

10. The method of claim 1, further comprising, subsequent to receiving the payment authorization response message, storing, by the MRP switch computer, the payment authorization response and the electronic receipt.

11. The method of claim 1, further comprising, subsequent to receiving the payment authorization request:
failing to verify the originating service manager identifier; and
transmitting a message to the originating service manager denying the payment authorization request.

12. A computer readable medium storing non-transitory instructions for controlling a mobile remote payment switch processor, the instructions configured to cause the processor to:
receive a payment authorization request that comprises payment data, an originating service manager identifier, and a merchant identifier;
verify the originating service manager identifier;
determine that the merchant is affiliated with an acquirer financial institution;
generate enriched payment instructions that include a switching identifier and a payment gateway identifier;
transmit the enriched payment instructions to an acquirer financial institution computer;
receive a payment authorization response from the acquirer financial institution computer;
generate a document control file, billing events data, and a digital receipt; and
transmit the digital receipt to a merchant device of the merchant and to an originating service manager computer.

13. A system for handling mobile remote payment transactions, comprising:
an originating service manager computer configured for receiving a payment authorization request from a consumer device, for authenticating the consumer device, and for transmitting the payment authorization request;
a mobile remote payment (MRP) switch computer configured for receiving the payment authorization request from the originating service manager computer, determining a receiving service manager computer associated with a merchant identifier, generating enriched payment instructions, and transmitting the enriched payment instructions to the receiving service manager computer; and
a receiving service manager computer configured for receiving the enriched payment instructions, routing the payment authorization request to an acquirer financial institution, receiving a payment authorization response and electronic receipt, and transmitting the payment authorization response and electronic receipt to the MRP switch computer and to a merchant device;
wherein the MRP switch computer is also configured for receiving the payment authorization response and electronic receipt from the receiving service manager computer, transmitting the payment authorization response and electronic receipt to the originating service manager computer, and receiving an acknowledgment message from the originating service manager computer.

14. A method comprising:
receiving, by a mobile remote payment (MRP) switch computer from an originating service manager computer, a payment authorization request that comprises payment data, an originating service manager identifier, and a merchant identifier;
verifying the originating service manager identifier;
determining that the merchant is affiliated with an acquirer financial institution;
generating, by the MRP switch computer, enriched payment instructions that include a switching identifier and a payment gateway identifier;
transmitting the enriched payment instructions to the acquirer financial institution computer;
receiving, by the MRP switch computer, a payment authorization response from the acquirer financial institution computer;
generating, by the MRP switch computer, a document control file, billing events data, and a digital receipt; and
transmitting the digital receipt to a merchant device of the merchant and to the originating service manager computer.

15. The method of claim 14, further comprising transmitting, by the originating service manager computer, the digital receipt to a consumer device.

16. The method of claim 14, further comprising providing, by the MRP switch computer, value added services to at least one of the consumer, the merchant, and a financial institution.

17. The method of claim 14, further comprising receiving, by the MRP switch computer, an acknowledgement message from the originating service manager computer acknowledging receipt of the digital receipt.

18. The method of claim 17, further comprising storing the acknowledgement message in a storage device of the MRP switch computer to ensure non-repudiation.

19. The method of claim 14, further comprising storing the payment authorization response and the electronic receipt in a storage device of the MRP switch computer.

20. The method of claim 14, wherein the enriched payment instructions further comprises at least one of an originating service manager identifier and a MRP merchant identifier.

21. The method of claim 15, further comprising, subsequent to determining the acquirer financial institution, storing the enriched payment instructions for non-repudiation and data integrity purposes.

22. The method of claim 14, further comprising, subsequent to receiving the payment authorization response message, storing, by the MRP switch computer, the payment authorization response and the electronic receipt.

23. The method of claim 14, further comprising, subsequent to receiving the payment authorization request:
failing to verify the originating service manager identifier; and
transmitting a message to the originating service manager denying the payment authorization request.

24. A computer readable medium storing non-transitory instructions for controlling a mobile remote payment switch processor, the instructions configured to cause the processor to:
receive a payment authorization request that comprises payment data, an originating service manager identifier, and a merchant identifier of a merchant;
verify the originating service manager identifier;
determine that the merchant is affiliated with an acquirer financial institution;
generate enriched payment instructions that include a switching identifier and a payment gateway identifier;
transmit the enriched payment instructions to an acquirer financial institution computer;
receive a payment authorization response from the acquirer financial institution computer;
generate a document control file, billing events data, and a digital receipt; and
transmit the digital receipt to a merchant device of the merchant and to an originating service manager computer.

25. A system for handling mobile remote payment transactions, comprising:
an originating service manager computer configured for receiving a payment authorization request from a consumer device, for authenticating the consumer device, and for transmitting the payment authorization request;
a mobile remote payment (MRP) switch computer configured for receiving the payment authorization request from the originating service manager computer, determining an acquirer financial institution associated with a merchant identifier, generating enriched payment instructions, and transmitting the enriched payment instructions to the acquirer financial institution; and
an acquirer financial institution computer configured for receiving the enriched payment instructions, routing the payment authorization request to a payment network, receiving a payment authorization response, generating a digital receipt, and transmitting the payment authorization response and digital receipt to the MRP switch computer;
wherein the MRP switch computer is also configured for receiving the payment authorization response and digital receipt from the acquirer financial institution computer, transmitting the payment authorization response and digital receipt to the originating service manager computer, transmitting the digital receipt to a merchant device, and receiving an acknowledgment message from the originating service manager computer.
